(19) United States
(12) Patent Application Publication
(10) Pub. No.: US 2016/0312075 A1
(43) Pub. Date: Oct. 27, 2016

(54) SCREEN PROTECTION STICKER STRUCTURE

(71) Applicant: Shih-Hsun Chiou, Taipei City (TW)

(72) Inventor: Shih-Hsun Chiou, Taipei City (TW)

(21) Appl. No.: 14/693,216

(22) Filed: Apr. 22, 2015

(51) Int. Cl. C09J 7/02

(52) U.S. Cl. CPC C09J 7/0264; C09J 2201/122; C09J 2201/162

(57) ABSTRACT

A screen protection sticker structure, comprising: a plastic layer, having a first surface and a second surface; a masking layer, covering the first surface of the plastic layer, and defining a hollowed-out area; a UV restorative layer, covering the second surface of the plastic layer; an anti-pollution layer, covering the UV restorative layer; and an adhesion layer, configured under the masking layer, to be attached to the screen surface of the electronic product in a detachable fashion.

### BACKGROUND OF INVENTION

1. Field of the Invention

The present invention relates to a screen safety protection means, and more particularly to a screen protection sticker structure which is bonded onto the screen surface and which is capable of self-recovery (self-restoration) after scratch so as to maintain the normal visual effect.

2. Description of Related Art

Nowadays, electronic products with touch screens are widely used. To avoid scratch and damage of the screen, users would usually cover the screen with a protection sticker so as to protect the screen.

A commonly-seen protection sticker generally comprises a film body, an adhesion layer bonded on one side of the film body, and a release layer bonded on one side of the adhesion layer. In particular, the adhesion layer is to be attached to the screen surface of the electronic product, and the release layer is to protect the unused condition of the adhesion layer. To use the protection sticker, just remove the release layer and the film body can be attached to the screen surface through the adhesion layer.

Protection stickers shall at least have the following properties: product beautification, no adhesive residue, easy re-work, basic anti-pollution function, resistance to scratch and good transparency. However, in consideration of the manufacturing costs, most manufacturers would probably choose low-cost materials, such as: polyethylene terephthalate (PET), polycarbonate (PC), O-phenylphenol (OPP), casting polypropylene (CPP), glycol-polyethylene terephathalate (PETG) etc. Although these materials can achieve the basic functions as stated above, their protective function is not so good. Even minor scratches may leave scratch marks on the screen surface and consequently affect the normal visibility; In particular, users may put the electronic product in their handbag or pocket when they are walking or going out, and it will easily scratch against objects like keys, coins, a watch, a ring, or even powders or dusts. As a result, due to scratches all over the surface, the protective function of the protection sticker will become ineffective.

Thus, to overcome the aforementioned problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The main objective of the present invention is to provide an innovative screen protection sticker structure to achieve functions of shock-absorption and self-restoration through a thin flexible layer made of specific compositions as well as a multi-layer composite structure.

To realize the above objective, the technical means adopted by the present invention is to design a protection sticker structure, at least comprising: a plastic layer, having a first surface and a second surface; a masking layer, covering the first surface of the plastic layer, and defining a hollowed-out area; a UV restorative layer, covering the second surface of the plastic layer; an anti-pollution layer, covering the UV restorative layer; and an adhesion layer, configured under the masking layer, to be attached to the screen surface of the electronic product in a detachable fashion.

Based on this, when the screen protection sticker structure is applied on the screen surface of various electronic products, the shock-absorption function of the UV restorative layer will enable self-restoration after minor scratches, so as to protect the screen from hurt and maintain the original visual effect.

The compositions of the above-stated UV restorative layer include: urethane acrylate and monomer accounting for 36˜40%, methyl isobutyl ketone accounting for 25˜29%, methyl ethyl ketone accounting for 25˜29%, propylene glycol monomethyl ether accounting for 6˜8%, and additives accounting for 1˜3%.

Optimal range of thickness of the above-stated UV restorative layer is 100˜300 μm.

Optimal range of thickness of the above-stated plastic layer is 0.08˜0.7 mm.

Optimal range of thickness of the above-stated masking layer is 50˜120 μm.

The above-stated screen protection sticker structure further includes at least one opening, configured on the surface outside the hollowed-out area.

### BRIEF DESCRIPTION OF THE DRAWINGS

FIG. 1 is an appearance view of the first embodiment of the present invention of a screen protection sticker structure;

FIG. 2 is an A-A′ sectional view of the first embodiment of the present invention of a screen protection sticker structure.

### DETAILED DESCRIPTION OF THE INVENTION

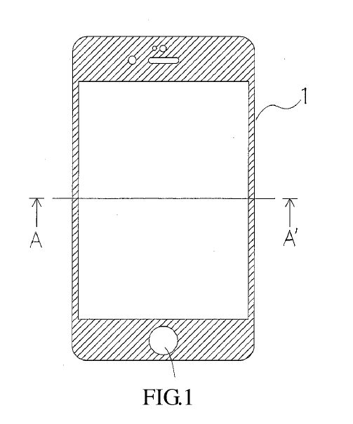

Referring to FIG. 1, which discloses the appearance of an embodiment of the screen protection sticker structure, said protection sticker structure (1) can be used for the display screen of a general electronic product, and after implementation, it can protect the display screen from damage when the electronic product is carried or touched; in addition, said protection sticker structure (1) has at least one opening (11), its size and shape matching the functional button, microphone or lens of the electronic product, so as not to affect the normal operational (working) conditions of such functions.

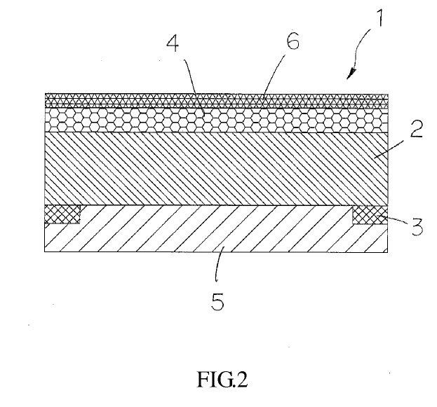

Further referring to FIG. 2, which depicts an A-A′ sectional view of the screen protection sticker structure, it can be clearly seen that the structure at least comprises: a plastic layer (2), have a first surface (the lower surface in drawing) and a second surface (the upper surface in the drawing); a masking layer (3) covering the first surface of the plastic layer (2), and defining a hollowed-out area (31), and the shape and size of the hollowed-out area (31) matching the display screen of the electronic product to be applied with the protection layer; a UV restorative layer (4), covering the second surface of the plastic layer (2); an anti-pollution layer (6), covering the UV restorative layer (4); and an adhesion layer (5), configured under the masking layer (3), and to be attached to the display screen of the electronic product in a detachable fashion.

In a preferred embodiment, the structures of each layer of the screen protection sticker structure (1) respectively adopt the following specifications, wherein: said plastic layer (2) can adopt any of such composite materials as: polycarbonate (PC), polymethylmethacrylate (PMMA), or polyethylene Terephthalate (PET), and optimal thickness of 0.08˜0.7 mm; said masking layer (3) is printing ink, with optimal thickness of 50˜120 μm; said UV restorative layer (4) can be implemented with optimal thickness of 100˜300 μm, the thickness of the adhesion layer (5) is lower than that of the masking layer (3), the adhesion layer (5) can use anti-static glue, and the application area shall include the total of the masking layer (4) (corresponding to the periphery of the screen) and the UV restorative layer (4) (corresponding to the screen area).

Specifically, the compositions of the UV restorative layer (4) shall at least include: urethane acrylate and monomer, methyl isobutyl ketone, methyl ethyl ketone, propylene glycol monomethyl ether and additives; in particular, urethane acrylate and monomer accounts for 36—40%, methyl isobutyl ketone accounts for 25—29%, methyl ethyl ketone accounts for 25—29%, propylene glycol monomethyl ether accounts for 6—8%, and additives accounts for 1—3%; a thin and flexible UV restorative layer (4) made of such a mixture can have effective shock absorption, and is capable of self-recovery after minor scratches. Hence, it can protect the screen from hurt and can maintain the original visual effect in usage.

Based on the above-stated design of the screen protection sticker structure, when the present invention is attached to the screen surface of an electronic product, through the function of the flexible UV restorative layer, it can automatically restore after minor collision or scratch, the dent or damage can be recovered and the normal visibility will not be affected. Meanwhile, the anti-pollution layer (6) can effectively reduce or avoid residues of fingerprint or greasy dirt. In this way, the present invention can not only protect the screen, but also provide an anti-pollution function.

Although the invention has been explained in relation to its preferred embodiment, it is to be understood that many other possible modifications and variations can be made without departing from the spirit and scope of the invention as hereinafter claimed.

1. A screen protection sticker structure, comprising:
a plastic layer, having a first surface and a second surface;
a masking layer, covering the first surface of the plastic layer, and defining a hollowed-out area;
a UV restorative layer, covering the second surface of the plastic layer;
an anti-pollution layer, covering the UV restorative layer; and
an adhesion layer, configured under the masking layer, to be attached to the screen surface of the electronic product in a detachable fashion.

2. The screen protection sticker structure as claimed in claim 1, wherein the compositions of the UV restorative layer include: urethane acrylate and monomer accounting for 36˜40%, methyl isobutyl ketone accounting for 25˜29%, methyl ethyl ketone accounting for 25˜29%, propylene glycol monomethyl ether accounting for 6˜8%, and additives accounting for 1˜3%.

3. The screen protection sticker structure as claimed in claim 1, wherein the optimal range of thickness of the UV restorative layer is 100˜300 μm.

4. The screen protection sticker structure as claimed in claim 1, wherein the optimal range of thickness of the plastic layer is 0.08˜0.7 mm.

5. The screen protection sticker structure as claimed in claim 1, wherein the optimal thickness of the masking layer is 50˜120 μm.

6. The screen protection sticker structure as claimed in claim 1, wherein said screen protection sticker structure further includes at least one opening, configured on the surface outside the hollowed-out area.
